(19) United States
(12) Patent Application Publication
(10) Pub. No.: US 2016/0319045 A1
(43) Pub. Date: Nov. 3, 2016

(54) MODIFIED DIENE ELASTOMER AND RUBBER COMPOSITION CONTAINING SAME

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Charlotte DIRE, Clermont-Ferrand (FR); Jean-Marc MARECHAL, Clermont-Ferrand (FR); Margarita DORATO, Clermont-Ferrand (FR)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 15/105,181

(22) PCT Filed: Dec. 18, 2014
(86) PCT No.: PCT/EP2014/078557

§ 371 Date: Jun. 16, 2016

(30) Foreign Application Priority Data
Dec. 18, 2013 (FR) 1362870

(51) Int. Cl. C08C 19/25; C08K 3/04; C08K 3/36

(52) U.S. Cl. CPC C08C 19/25; C08K 3/36; C08K 3/04

(57) ABSTRACT

A modified diene elastomer, a process of preparing the elastomer is provided. The modified diene elastomer comprises:
(i) from 40 to 80% by weight of the entity functionalized at the chain end by an alkylalkoxysilane group, optionally partially or completely hydrolysed to give silanol, bearing a primary, secondary or tertiary amine function, and bonded to the elastomer via the silicon atom,
(ii) from 5 to 45% by weight of the entity functionalized in the middle of the chain by an alkoxysilane group, optionally partially or completely hydrolysed to give silanol, bearing a primary, secondary or tertiary amine function, and the silicon atom of which bonds the two pieces of the chain,
(iii) from 3 to 30% by weight of the three-branch star-branched entity containing a silane functional group, bearing a primary, secondary or tertiary amine function, and the silicon atom of which bonds the three branches of the chain.

This application is a 371 national phase entry of PCT/EP2014/078557, filed 18 Dec. 2014, which claims benefit of French Patent Application No. 1362870, filed 18 Dec. 2013, the entire contents of which are incorporated herein by reference for all purposes.

### BACKGROUND

1. Technical Field

The invention relates to a diene elastomer modified by functionalization agents of the type of di- and trialkoxysilanes bearing amine functions. The invention also relates to a process for the preparation of such a diene elastomer, to a composition comprising it and also to a semi-finished article and a tire comprising this composition.

2. Related Art

Now that savings in fuel and the need to protect the environment have become a priority, it is desirable to produce mixtures having a hysteresis which is as low as possible. This reduction in the hysteresis is an ongoing objective which has, however, to be done while retaining the suitability for processing, in particular in the raw state, of the mixtures, so as to be able to use them as rubber compositions in the manufacture of various finished products participating in the composition of tire casings, such as, for example, underlayers, sidewalls or treads, and in order to obtain tires having a reduced rolling resistance.

Many solutions have already been experimented with in order to achieve the objective of fall in hysteresis. Mention may in particular be made of the modification of the structure of diene polymers and copolymers for the purpose of polymerization by means of functionalization agents or else the use of functional initiators, the aim being to obtain a good interaction between the polymer, thus modified, and the filler, whether carbon black or a reinforcing inorganic filler.

Mention may be made, by way of illustration of this prior art, of the use of diene elastomers functionalized by alkoxysilane compounds bearing an amine function.

Mention may be made of Patent FR 2 867 477 A1, which claims the functionalization at the chain end with compounds of (dialkylaminoalkyl)trialkoxysilane type, and also a rubber composition based on silica or carbon black. Mention may also be made of patents U.S. Pat. No. 8,071,689 B2 and U.S. Pat. No. 8,106,130 B2, which respectively claim, for one, the functionalization at the chain end with a trialkoxysilane compound bearing a nitrogen-based group, the nitrogen atom being included in a substituted or unsubstituted aromatic heterocycle, and, for the other, with an alkoxysilane bearing an amine function having at least one alkoxysilyl group and at least two tertiary amine groups.

In patent U.S. Pat. No. 7,807,747 B2, provision is made to improve the processability (mixing aspect after passing over open mills) of the raw mixtures containing elastomers functionalized with compounds of the aminoalkoxysilane type and synthesized according to a batch process. The strategy consists in adding the aminoalkoxysilane compound, preferably of the (aminoalkyl)trialkoxysilane type, in two steps during the functionalization stage: i) 1^{st} addition in an amount such that the n((aminoalkyl)trialkoxysilane)/n(initiator based on alkali metal) molar ratio is between 0.05 and 0.35, ii) then 2^{nd} addition in an amount such that the n((aminoalkyl)trialkoxysilane)/n(initiator based on alkali metal) final molar ratio is greater than or equal to 0.5. This process makes it possible to obtain a functional diene elastomer mixture comprising from 40 to 80% by weight of elastomer functionalized at the chain end, from 5 to 45% by weight of elastomer functionalized in the middle of the chain and from 3 to 30% by weight of star-branched elastomer (3-branch stars).

These functionalized elastomers have been described in the prior art as effective in reducing the hysteresis. Nevertheless, it turns out that the Mooney viscosity of such elastomers is not always stable on storage, which can result in problems of industrial robustness.

Various strategies have been experimented with in order to stabilize the Mooney viscosity on storage of elastomers bearing alkoxysilane functional groups. Mention may be made, by way of illustration, of Patent EP 0 299 074 B1, which claims the use of specific alkoxysilanes (Si(OR)ₓ with R=non-hydrolysable group containing from 4 to 20 carbons). Mention may also be made of Patent EP 0 801 078 B1, which claims the addition of a carboxylic acid to the elastomer solution, with an n(carboxylic acid)/n(anionic polymerization initiator) molar ratio of between 0.8 and 1.2, before the stripping stage, in order to neutralize the basicity contributed by the anionic polymerization initiator and to minimize the hydrolysis of the alkoxysilane groups. In Patent EP 1 1985 06 B1, provision is made to add a compound of the alkylalkoxysilane type (R¹ₙSi(OR²)₄₋ₙ) to the elastomer solution, before the stripping stage, with a high (20/1) n(R¹ₙSi(OR²)₄₋ₙ)/n(Polymer-SiOR′) molar ratio in order to promote the reaction between the alkylalkoxysilane and the polymer, which is in its hydrolysed form, Polymer-SiOH, in the stripping. Finally, mention may be made of Patent EP 1 237 934 B1, which claims the addition of a long-chain alcohol to the elastomer solution before the stripping stage, in order to minimize the hydrolysis reactions in the stripping and consequently the formation of Si—O—Si bonds.

In the light of the state of the art, there exists a need to provide a functionalized elastomer for the purpose of obtaining rubber compositions possessing an improved hysteresis/processability of the rubber composition compromise, while improving the stability on storage of the Mooney viscosity of the functionalized elastomer participating in its composition.

### SUMMARY

The aim of the present invention is thus to provide such a composition. One objective is in particular to provide a functionalized elastomer which interacts satisfactorily with the reinforcing filler of a rubber composition containing it in order to decrease the hysteresis thereof, while improving the processability and the stability on storage of the Mooney viscosity of the elastomer.

This aim is achieved in that the Applicant Companies have just discovered, surprisingly, during their research studies, that a modified diene elastomer comprising:

(i) from 40 to 80% by weight, with respect to the total weight of the said modified diene elastomer, of the entity functionalized at the chain end by an alkylalkoxysilane group, optionally partially or completely hydrolysed to give silanol, bearing a primary, secondary or tertiary amine function, and bonded to the elastomer via the silicon atom,

(ii) from 5 to 45% by weight, with respect to the total weight of the said modified diene elastomer, of the entity functionalized in the middle of the chain by an alkoxysilane group, optionally partially or completely hydrolysed to give silanol, bearing a primary, secondary or tertiary amine function, and the silicon atom of which bonds the two pieces of the chain,

(iii) from 3 to 30% by weight, with respect to the total weight of the said modified diene elastomer, of the three-branch star-branched entity containing a silane functional group, bearing a primary, secondary or tertiary amine function, and the silicon atom of which bonds the three branches of the chain,

makes it possible to decrease the hysteresis, while improving the processability and the stability on storage of the Mooney viscosity.

A subject-matter of the invention is thus a modified diene elastomer comprising:

(i) from 40 to 80% by weight, with respect to the total weight of the said modified diene elastomer, of the entity functionalized at the chain end by an alkylalkoxysilane group, optionally partially or completely hydrolysed to give silanol, bearing a primary, secondary or tertiary amine function, and bonded to the elastomer via the silicon atom,

(ii) from 5 to 45% by weight, with respect to the total weight of the said modified diene elastomer, of the entity functionalized in the middle of the chain by an alkoxysilane group, optionally partially or completely hydrolysed to give silanol, bearing a primary, secondary or tertiary amine function, and the silicon atom of which bonds the two pieces of the chain,

(iii) from 3 to 30% by weight, with respect to the total weight of the said modified diene elastomer, of the three-branch star-branched entity containing a silane functional group, bearing a primary, secondary or tertiary amine function, and the silicon atom of which bonds the three branches of the chain.

Another subject-matter of the invention is a process for the synthesis of the said modified diene elastomer.

Another subject-matter of the invention is a reinforced rubber composition based at least on a reinforcing filler and on an elastomer matrix comprising at least the said modified diene elastomer.

### DETAILED DESCRIPTION OF EXAMPLE EMBODIMENTS

In the present description, unless expressly indicated otherwise, all the percentages (%) shown are % by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

It should be specified that it is known to a person skilled in the art that, when an elastomer is modified by reaction of a functionalization agent with a living elastomer resulting from an anionic polymerization stage, a mixture of modified entities of this elastomer is obtained, the composition of which depends in particular on the proportion of reactive sites of the functionalization agent with respect to the number of living chains. This mixture can comprise entities functionalized at the chain end, coupled, star-branched and/or non-functionalized.

When the elastomeric entity possesses an alkylalkoxysilane functional group, optionally partially or completely hydrolysed to give silanol, bearing a primary, secondary or tertiary amine function, at a chain end, it will then be said that the entity is functionalized at the chain end. The silicon atom of this group is directly bonded to the chain of the diene elastomer and is substituted only by a single alkoxy group, in addition to the alkyl radical and the group comprising the amine function.

When the elastomeric entity possesses an alkoxysilane functional group, optionally partially or completely hydrolysed to give silanol, bearing a primary, secondary or tertiary amine function, within its elastomer chain, the silicon atom of this group bonding the two pieces of the diene elastomer chain, it is said that the elastomer is coupled or alternatively functionalized in the middle of the chain, in contrast to the position “at the chain end”, or the group is not located precisely in the middle of the elastomer chain.

When a silane functional group, bearing a primary, secondary or tertiary amine function, is central, to which three elastomer chains or branches are bonded, forming a star-branched structure of the elastomer, it will then be said that the entity is star-branched. The silicon atom of this group bonds the three branches of the modified diene elastomer to one another.

The expression “composition based on” should be understood as meaning a composition comprising the mixture and/or the reaction product of the various constituents used, some of these base constituents being capable of reacting or intended to react with one another, at least in part, during the various phases of manufacture of the composition, in particular during the crosslinking or vulcanization thereof.

The term “diene elastomer” should be understood, in a known way, as meaning an (one or more is understood) elastomer resulting at least in part (i.e., a homopolymer or a copolymer) from diene monomers (monomers bearing two conjugated or non-conjugated carbon-carbon double bonds). More particularly, the term “diene elastomer” is understood to mean any homopolymer obtained by polymerization of a conjugated diene monomer having from 4 to 12 carbon atoms or any copolymer obtained by copolymerization of one or more conjugated dienes with one another or with one or more vinylaromatic compounds having from 8 to 20 carbon atoms. In the case of copolymers, the latter contain from 20% to 99% by weight of diene units and from 1% to 80% by weight of vinylaromatic units.

The following in particular are suitable as conjugated dienes which can be used in the process in accordance with the invention: 1,3-butadiene, 2-methyl-1,3-butadiene, 2,3-di(C₁ to C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, phenyl-1,3-butadiene, 1,3-pentadiene and 2,4-hexadiene, and the like.

The following in particular are suitable as vinylaromatic compounds: styrene, ortho-, meta- or para-methylstyrene, a-methylstyrene, the “vinyltoluene” commercial mixture, para-(tert-butyl)styrene, methoxystyrenes, vinylmesitylene, divinylbenzene and vinylnaphthalene, and the like.

The diene elastomer of the invention is preferably selected from the group of highly unsaturated diene elastomers consisting of polybutadienes (BRs), synthetic polyisoprenes (IRs), butadiene copolymers, in particular copolymers of butadiene and of a vinylaromatic monomer, isoprene copolymers and the mixtures of these elastomers. Such copolymers are more particularly butadiene/styrene copolymers (SBRs), isoprene/butadiene copolymers (BIRs), isoprene/styrene copolymers (SIRs) and isoprene/butadiene/styrene copolymers (SBIRs). Among these copolymers, butadiene/styrene copolymers (SBRs) are particularly preferred.

The entity (i) functionalized at the chain end by an alkylalkoxysilane group, optionally partially or completely hydrolysed to give silanol, bearing a primary, secondary or tertiary amine function, and bonded to the elastomer via the silicon atom, preferably corresponds to the following formula (I):

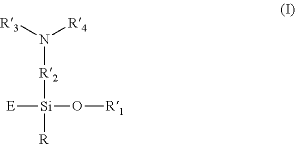

in which:
E denotes the diene elastomer,
R denotes a linear or branched C₁-C₁₀, preferably C₁-C₄, alkyl radical, more preferably a methyl radical,
R′₁ denotes, as a function of the degree of hydrolysis, a hydrogen atom or a linear or branched C₁-C₁₀, preferably C₁-C₄, alkyl radical, more preferably a methyl or ethyl radical,
R′₂ is a saturated or unsaturated, cyclic or non-cyclic, divalent C₁-C₁₈ aliphatic hydrocarbon group or a divalent C₆-C₁₈ aromatic hydrocarbon group, preferably a linear divalent C₁-C₆ aliphatic hydrocarbon group, more preferably the saturated linear divalent C₃ aliphatic hydrocarbon radical,
R′₃ and R′₄, which are identical or different, represent a hydrogen atom or a linear or branched C₁-C₁₈, preferably C₁-C₄, alkyl radical, more preferably a methyl or ethyl radical, or else R′₃ and R′₄ form, with N to which they are bonded, a heterocycle containing a nitrogen atom and at least one carbon atom, preferably from 2 to 6 carbon atoms.

According to advantageous alternative forms of the invention, at least one of the four following characteristics is observed and preferably the four:
R represents a methyl radical,
R′₁ represents a hydrogen atom or a methyl or ethyl radical, preferably a hydrogen atom,
R′₂ represents the saturated linear divalent C₃ aliphatic hydrocarbon radical,
R′₃ and R′₄, which are identical or different, preferably identical, represent a methyl or ethyl radical, preferably a methyl radical.

The entity (ii) functionalized in the middle of the chain by an alkoxysilane group, optionally partially or completely hydrolysed to give silanol, bearing a primary, secondary or tertiary amine function, and the silicon atom of which bonds the two pieces of the chain, preferably corresponds to the following formula (II):

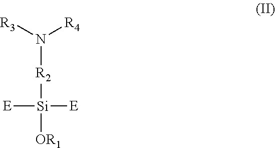

in which:
E denotes the diene elastomer,
R₁ denotes, as a function of the degree of hydrolysis, a hydrogen atom or a linear or branched C₁-C₁₀, preferably C₁-C₄, alkyl radical, more preferably a methyl or ethyl radical,
R₂ is a saturated or unsaturated, cyclic or non-cyclic, divalent C₁-C₁₈ aliphatic hydrocarbon group or a divalent C₆-C₁₈ aromatic hydrocarbon group, preferably a linear divalent C₁-C₆ aliphatic hydrocarbon group, more preferably the saturated linear divalent C₃ aliphatic hydrocarbon radical,
R₃ and R₄, which are identical or different, represent a hydrogen atom or a linear or branched C₁-C₁₈, preferably C₁-C₄, alkyl radical, more preferably a methyl or ethyl radical, or else R₃ and R₄ form, with N to which they are bonded, a heterocycle containing a nitrogen atom and at least one carbon atom, preferably from 2 to 6 carbon atoms.

According to advantageous alternative forms of the invention, at least one of the three following characteristics is observed and preferably the three:
R₁ represents a hydrogen atom or a methyl or ethyl radical, preferably a hydrogen atom,
R₂ represents the saturated linear divalent C₃ aliphatic hydrocarbon radical,
R₃ and R₄, which are identical or different, preferably identical, represent a methyl or ethyl radical, preferably a methyl radical.

The three-branch star-branched entity (iii) containing a silane functional group bearing a primary, secondary or tertiary amine function, and the silicon atom of which bonds the three branches of the chain, preferably corresponds to the following formula (III):

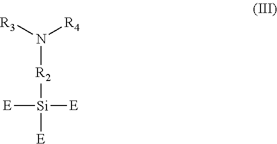

in which R₂, R₃ and R₄ are as defined above.

The different aspects, preferred or not, which precede can be combined with one another.

The modified diene elastomer according to the invention can be prepared according to a process including the modification of the elastomer by reaction of a living diene elastomer with two appropriate functionalization agents. Such a process also forms the subject-matter of the invention.

Thus, the modified diene elastomer is obtained by the process comprising the following stages:

1) anionic polymerization of at least one conjugated diene in the presence of a polymerization initiator in order to form a living diene elastomer, then

2) addition, to the living diene elastomer obtained in stage 1), of a trialkoxysilane compound bearing a protected primary amine, protected secondary amine or tertiary amine function, the trialkoxysilane bearing a protected primary amine, protected secondary amine or tertiary amine function/polymerization initiator molar ratio varying from 0.05 to 0.35, then

3) addition, to the elastomer solution obtained on conclusion of stage 2), of an alkyldialkoxysilane compound bearing a protected primary amine, protected secondary amine or tertiary amine function, the alkyldialkoxysilane bearing a protected primary amine, protected secondary amine or tertiary amine function/polymerization initiator used in stage 1) molar ratio being greater than or equal to 0.8. The polymerization of diene monomers is initiated by an initiator. Use may be made, as polymerization initiator, of any known monofunctional anionic initiator. However, an initiator containing an alkali metal, such as lithium, is preferably used.

Those comprising a carbon-lithium or nitrogen-lithium bond are suitable in particular as organolithium initiators. Representative compounds are aliphatic organolithium compounds, such as ethyllithium, n-butyllithium (n-BuLi), isobutyllithium, and the like, or lithium amides obtained from a secondary amine and more particularly those obtained from a cyclic secondary amine, such as pyrrolidine or hexamethyleneimine.

The polymerization is preferably carried out in the presence of an inert hydrocarbon solvent which can, for example, be an aliphatic or alicyclic hydrocarbon, such as pentane, hexane, heptane, isooctane, cyclohexane or methylcyclohexane, or an aromatic hydrocarbon such as benzene, toluene or xylene.

The polymerization can be carried out continuously or batchwise. The polymerization is generally carried out at a temperature of between 20° C. and 150° C. and preferably in the vicinity of 30° C. to 110° C.

The second stage of the process consists of the modification of the living diene elastomer, obtained on conclusion of the anionic polymerization stage, according to operating conditions which promote the star-branching and coupling reactions of the diene elastomer by a functionalization agent of the type of trialkoxysilane bearing a protected primary amine, protected secondary amine or tertiary amine function.

This trialkoxysilane compound bearing a protected primary amine, protected secondary amine or tertiary amine function preferably corresponds to the following formula (IV):

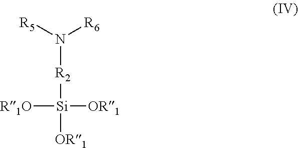

in which:
the linear or branched R″₁ radicals, which are identical to or different from one another, represent a C₁-C₁₀, preferably C₁-C₄, alkyl group, better still a methyl or ethyl radical,
   R₂ is a saturated or unsaturated, cyclic or non-cyclic, divalent C₁-C₁₈ aliphatic hydrocarbon group or a divalent C₆-C₁₈ aromatic hydrocarbon group, preferably a linear divalent C₁-C₆ aliphatic hydrocarbon group, more preferably the saturated linear divalent C₃ aliphatic hydrocarbon radical,
   R₅ and R₆, which are identical or different, represent a trialkylsilyl radical, the alkyl groups, which are identical or different, having from 1 to 4 carbon atoms, or a linear or branched C₁-C₁₈, preferably C₁-C₄, alkyl radical, more preferably a methyl or ethyl radical, or else R₅ and R₆ form, with N to which they are bonded, a heterocycle containing a nitrogen atom and at least one carbon atom, preferably from 2 to 6 carbon atoms.

Mention may be made, as functionalization agent, of (N,N-dialkylaminopropyl)trialkoxysilanes, (N-alkylaminopropyl)trialkoxysilanes, the secondary amine function of which is protected by a trialkylsilyl group, and aminopropyltrialkoxysilanes, the primary amine function of which is protected by two trialkylsilyl groups.

According to alternative forms, the functionalization agent can be chosen from (3-N,N-dimethylaminopropyl)trimethoxysilane, (3-N,N-dimethylaminopropyl)tri ethoxysilane, (3-N,N-di ethylamino-propyl)trimethoxysilane, (3-N,N-di ethylaminopropyl)triethoxysilane, (3-N,N-dipropylaminopropyl)trimethoxysilane, (3-N,N-dipropylamino-propyl)triethoxysilane, (3-N,N-dibutylaminopropyl)trimethoxysilane, (3-N,N-dibutylaminopropyl)triethoxysilane, (3-N,N-dipentylamino-propyl)trimethoxysilane, (3-N,N-dipentylaminopropyl)tri ethoxysilane, (3-N,N-dihexylaminopropyl)trimethoxysilane, (3-N,N-dihexylamino-propyl)triethoxysilane, (3-hexamethyleneaminopropyl)trimethoxy-silane, (3-hexamethyleneaminopropyl)triethoxysilane, (3-morpholino-propyl)trimethoxysilane, (3-morpholinopropyl)tri ethoxysilane, (3-piperidinopropyl)trimethoxysilane and (3-piperidinopropyl)tri-ethoxysilane. Preferably, the coupling agent is then (3-N,N-dimethyl-aminopropyl)trimethoxysilane.

According to other alternative forms, the functionalization agent can be chosen from (3-N,N-methyltrimethylsilylamino-propyl)trimethoxysilane, (3-N,N-methyltrimethylsilylaminopropyl)tri-ethoxysilane, (3-N,N-ethyltrimethylsilylaminopropyl)trimethoxysilane, (3-N,N-ethyltrimethylsilylaminopropyl)triethoxysilane, (3-N,N-propyl-trimethylsilylaminopropyl)trimethoxysilane and (3-N,N-propyltri-methylsilylaminopropyl)triethoxysilane. Preferably, the coupling agent is then (3-N,N-methyltrimethylsilylaminopropyl)trimethoxysilane.

According to yet other alternative forms, the functionalization agent can be chosen from (3-N,N-bistrimethylsilyl-aminopropyl)trimethoxysilane and (3-N,N-bistrimethylsilylamino-propyl)triethoxysilane. Preferably, the coupling agent is then (3-N,N-bistrimethylsilylaminopropyl)trimethoxysilane.

The mixing of the living diene polymer and of the trialkoxysilane compound bearing a protected primary amine, protected secondary amine or tertiary amine function can be carried out by any appropriate means. The reaction time between the living diene polymer and the aminotrialkoxysilane compound can be between 10 seconds and 2 hours.

The second stage of the process results in the formation of the entity (ii) functionalized in the middle of the chain by an alkoxysilane group, optionally partially or completely hydrolysed to give silanol, bearing a primary, secondary or tertiary amine function, and the silicon atom of which bonds the two pieces of the chain, and of the three-branch star-branched entity (iii) containing a silane functional group, bearing a primary, secondary or tertiary amine function, and the silicon atom of which bonds the three branches of the chain.

The third stage of the process consists of the modification of the living diene elastomer according to operating conditions which promote the functionalization reaction at the chain end of the diene elastomer by a functionalization agent of the type of alkyldialkoxysilane bearing a protected primary amine, protected secondary amine or tertiary amine function.

This alkyldialkoxysilane compound bearing a protected primary amine, protected secondary amine or tertiary amine function corresponds to the following formula (V):

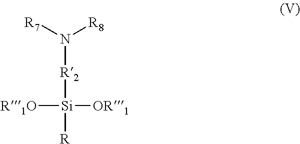

in which:
R denotes a linear or branched C₁-C₁₀, preferably C₁-C₄, alkyl radical, more preferably a methyl radical,
the R′″₁ radicals, which are identical to or different from one another, represent a linear or branched C₁-C₁₀, preferably C₁-C₄, alkyl radical, more preferably a methyl or ethyl radical,
R′₂ is a saturated or unsaturated, cyclic or non-cyclic, divalent C₁-C₁₈ aliphatic hydrocarbon group or a divalent C₆-C₁₈ aromatic hydrocarbon group, preferably a linear divalent C₁-C₆ aliphatic hydrocarbon group, more preferably the saturated linear divalent C₃ aliphatic hydrocarbon radical,
R₇ and R₈, which are identical or different, represent a trialkylsilyl radical, the alkyl groups, which are identical or different, having from 1 to 4 carbon atoms, or a linear or branched C₁-C₁₈, preferably C₁-C₄, alkyl radical, more preferably a methyl or ethyl radical, or else R₇ and R₈ form, with N to which they are bonded, a heterocycle containing a nitrogen atom and at least one carbon atom, preferably from 2 to 6 carbon atoms.

Mention may be made, as functionalization agent, of (N,N-dialkylaminopropyl)(alkyl)dialkoxysilanes, (N-alkylaminopropyl)(alk-yl)dialkoxysilanes, the secondary amine function of which is protected by a trialkylsilyl group, and (aminopropyl)(alkyl)dialkoxysilanes, the primary amine function of which is protected by two trialkylsilyl groups.

According to alternative forms, the functionalization agent can be chosen from (3-N,N-dimethylaminopropyl)(methyl)dimethoxy-silane, (3-N,N-dimethylaminopropyl)(methyl)diethoxysilane, (3-N,N-diethylaminopropyl)(methyl)dimethoxysilane, (3-N,N-diethylamino-propyl)(methyl)diethoxysilane, (3-N,N-dipropylaminopropyl)(meth-yl)dimethoxysilane, (3-N,N-dipropylaminopropyl)(methyl)diethoxy-silane, (3-N,N-dibutylaminopropyl)(methyl)dimethoxysilane, (3-N,N-dibutylaminopropyl)(methyl)diethoxysilane, (3-N,N-dipentylamino-propyl)(methyl)dimethoxysilane, (3-N,N-dipentylaminoprop-yl)(methyl)diethoxysilane, (3-N,N-dihexylaminopropyl)(methyl)di-methoxysilane, (3-N,N-dihexylaminopropyl)(methyl)diethoxysilane, (3-hexamethyleneaminopropyl)(methyl)dimethoxysilane, (3-hexa-methyleneaminopropyl)(methyl)diethoxysilane, (3-morpholinoprop-yl)(methyl)dimethoxy silane, (3-morpholinopropyl)(methyl)diethoxy-silane, (3-piperidinopropyl)(methyl)dimethoxysilane, and (3-piperidinopropyl)(methyl)diethoxysilane. Preferably, the coupling agent is then (3-N,N-dimethylaminopropyl)(methyl)dimethoxysilane.

According to other alternative forms, the functionalization agent can be chosen from (3-N,N-methyltrimethylsilyl-aminopropyl)(methyl)dimethoxysilane, (3-N,N-methyltrimethylsilyl-aminopropyl)(methyl)diethoxysilane, (3-N,N-ethyltrimethylsilylamino-propyl)(methyl)dimethoxy silane, (3-N,N-ethyltrimethylsilylamino-propyl)(methyl)diethoxysilane, (3-N,N-propyltrimethylsilylamino-propyl)(methyl)dimethoxy silane, (3-N,N-propyltrimethylsilyl-aminopropyl)(methyl)diethoxysilane. Preferably, the coupling agent is then (3-N,N-methyltrimethylsilylaminopropyl)(methyl)dimethoxy-silane.

According to yet other alternative forms, the functionalization agent can be chosen from (3-N,N-bistrimethylsilyl-aminopropyl)(methyl)dimethoxysilane and (3-N,N-bistrimethylsilyl-aminopropyl)(methyl)diethoxysilane. Preferably, the coupling agent is then (3-N,N-bistrimethylsilylaminopropyl)(methyl)dimethoxysilane.

The third stage of the process results in the formation of the entity (i) functionalized at the chain end by an alkylalkoxysilane group, optionally partially or completely hydrolysed to give silanol, bearing a primary, secondary, or tertiary amine function, and bonded to the elastomer via the silicon atom.

The process for the synthesis of the modified diene elastomer can be continued in a way known per se by the stages of recovery of the modified elastomer.

According to alternative forms of this process, these stages comprise a stripping stage for the purpose of recovering the elastomer resulting from the prior stages in dry form. This stripping stage can in particular have the effect of hydrolysing all or a portion of the hydrolysable alkoxysilane functions of the modified diene elastomer in order to convert them into silanol functions.

According to other alternative forms of this process, these stages comprise a specific hydrolysis stage devoted to the hydrolysis of all or a portion of the hydrolysable alkoxysilane functions of the modified diene elastomer in order to convert them into silanol functions. This complete or partial hydrolysis stage can be carried out in a way known per se, before an optional stripping stage, by addition of an acid or basic compound. Such hydrolysis stages are described for example, in the document EP 2 266 819 A1.

According to other alternative forms of this process, these stages comprise a specific stage of deprotection of the primary amine or of the secondary amine when at least one of the two functionalization agents used bears a protected primary amine or protected secondary amine function. This stage is carried out after the two functionalization stages, before an optional stripping stage. It is possible, by way of example, to react the chains functionalized by the protected amine group with an acid, a base, a fluorinated derivative, such as tetrabutylammonium fluoride, a silver salt, such as silver nitrate, and the like, in order to deprotect this or these amine function(s). These different methods are described in the work Protective Groups in Organic Synthesis, T. W. Green and P. G. M. Wuts, Third Edition, 1999. This deprotection stage can have the effect of hydrolysing all or a portion of the hydrolysable alkoxysilane functions of the modified diene elastomer in order to convert them into silanol functions.

As a result of the recognized effect of the functions which it bears on the hysteresis and the processability of reinforced rubber compositions, the modified diene elastomer is advantageously used in reinforced rubber compositions intended in particular for the manufacture of tires.

Thus, another subject-matter of the invention is a reinforced rubber composition based on at least one reinforcing filler and an elastomer matrix comprising at least one modified diene elastomer as described above. It should be understood that the rubber composition can comprise one or more of these modified diene elastomers. The reinforced rubber composition according to the invention can be provided in the crosslinked state or in the non-crosslinked, in other words crosslinkable, state.

The modified diene elastomer according to the invention can, according to different alternative forms, be used alone in the composition or as a blend with at least one other conventional diene elastomer, whether it is star-branched, coupled, functionalized or non-functionalized. Preferably, this other diene elastomer is selected from the group of highly unsaturated diene elastomers consisting of polybutadienes (BRs), synthetic polyisoprenes (IRs), natural rubber (NR), butadiene copolymers, isoprene copolymers and the mixtures of these elastomers. Such copolymers are more preferably selected from the group consisting of butadiene/styrene copolymers (SBRs), isoprene-butadiene copolymers (BIRs), isoprene/styrene copolymers (SIRs) and isoprene-butadiene-styrene copolymers (SBIRs). It is also possible to envisage a blend with any synthetic elastomer other than the diene elastomer, and even with any polymer other than an elastomer, for example a thermoplastic polymer.

It should be noted that the improvement in the properties of the composition will be greater as the proportion of the elastomer(s) different from the modified diene elastomers in this composition becomes lower.

Thus, preferably, the elastomer matrix predominantly comprises the modified diene elastomer.

When the conventional elastomer used in blending is natural rubber and/or one or more diene polymers, such as, for example, polybutadienes, polyisoprenes or butadiene-styrene or butadiene-styrene-isoprene copolymers, this elastomer or these elastomers, modified or unmodified, can then be present at from 1 to 70 parts by weight per 100 parts of modified diene elastomer.

More preferably, the elastomer matrix is composed solely of the modified diene elastomer.

The rubber composition comprises, besides at least one elastomer matrix as described above, at least one reinforcing filler.

Use may be made of any type of reinforcing filler known for its abilities to reinforce a rubber composition which can be used for manufacture of tire treads, for example carbon black, a reinforcing inorganic filler, such as silica, with which is combined, in a known way, a coupling agent, or also a mixture of these two types of filler.

The rubber composition according to the invention can also comprise all or a portion of the usual additives generally used in elastomer compositions intended for the manufacture of tires, such as, for example, pigments, non-reinforcing fillers, coupling activators, agents for covering the fillers or more generally processing agents, protective agents, such as antiozone waxes, chemical antiozonants or antioxidants, antifatigue agents, plasticizing agents, reinforcing or plasticizing resins, methylene acceptors (for example, phenolic novolak resin) or methylene donors (for example, HMT or H3M), such as described, for example, in Application WO 02/10269, a crosslinking system based either on sulphur or on sulphur donors and/or on peroxide and/or on bismaleimides, vulcanization accelerators or vulcanization activators.

The rubber composition according to the invention can subsequently be calendered, for example in the form of a sheet or a plaque, or also extruded, for example in order to form a rubber profiled element which can be used as a semi-finished product made of rubber intended for the tire.

Another subject-matter of the invention is a semi-finished article made of rubber for tires, comprising a rubber composition which is crosslinkable or crosslinked or composed of such a composition.

Due to the improvement in the compromise between hysteresis and processability of a reinforced rubber composition and stability on storage of the Mooney viscosity of the elastomer which participates in its composition, it should be noted that such a composition can constitute any semi-finished product of the tire and very particularly the tread.

A final subject-matter of the invention is thus a tire comprising a semi-finished article, in particular a tread.

The abovementioned characteristics, and also others, will be better understood on reading the following description of several implementational examples of the invention, given by way of illustration and without limitation.

### EXAMPLES

### Measurements and Tests Used

High-Resolution Size Exclusion Chromatography

The high-resolution SEC technique is used to determine the percentages by weight of the various populations of chains present in a polymer sample.

There is no specific treatment of the polymer sample before analysis. The latter is simply dissolved in the elution solvent at a concentration of approximately 1 g·l⁻¹. The solution is then filtered through a filter with a porosity of 0.45 μm before injection.

The apparatus used is a Waters Alliance 2695 chromatographic line. The elution solvent is tetrahydrofuran, the flow rate is 0.2 ml·min⁻¹ and the temperature of the system is 35° C. A set of three identical columns in series is used (Shodex, length 300 mm, diameter 8 mm). The number of theoretical plates of the set of columns is greater than 22 000. The volume of the solution of the polymer sample injected is 50 μl. The detector is a Waters 2414 differential refractometer and the software for making use of the chromatographic data is the Waters Empower system.

The calculated molar masses are relative to a calibration curve produced for SBRs having the following microstructure: 25% by weight of units of styrene type, 23% by weight of units of 1,2-type and 50% by weight of units of trans-1,4-type.

Mooney Viscosity

The Mooney ML₍₁₊₄₎100° C. viscosities of the elastomers are measured according to Standard ASTM D-1646.

Use is made of an oscillating consistometer as described in Standard ASTM D-1646. The Mooney plasticity measurement is carried out according to the following principle: the elastomer is moulded in a cylindrical chamber heated to 100° C. After preheating for one minute, the rotor rotates within the test specimen at 2 revolutions/minute and the working torque for maintaining this movement after rotating for 4 minutes is measured. The Mooney

ML₍₁₊₄₎ plasticity is expressed in “Mooney unit” (MU, with 1 MU=0.83N·m).

Differential Scanning Calorimetry

The glass transition temperatures (Tg) of the elastomers are determined using a differential scanning calorimeter.

Near-Infrared (NIR) Spectroscopy

The microstructure of the elastomers is characterized by the near-infrared (NIR) spectroscopy technique.

Near-infrared (NIR) spectroscopy is used to quantitatively determine the content by weight of styrene in the elastomer and also its microstructure (relative distribution of the 1,2-, trans-1,4- and cis-1,4-butadiene units). The principle of the method is based on the Beer-Lambert law generalized for a multicomponent system. As the method is indirect, it involves a multivariate calibration [Vilmin, F., Dussap, C. and Coste, N., Applied Spectroscopy, 2006, 60, 619-29] carried out using standard elastomers having a composition determined by ¹³C NMR. The styrene content and the microstructure are then calculated from the NIR spectrum of an elastomer film having a thickness of approximately 730 μm. The spectrum is acquired in transmission mode between 4000 and 6200 cm⁻¹ with a resolution of 2 cm⁻¹ using a Bruker Tensor 37 Fourier-transform near-infrared spectrometer equipped with an InGaAs detector cooled by the Peltier effect.

Examples of the Preparation of Modified Elastomers

Preparation of the Polymer A—Polymer According to an Embodiment of the Invention

2.0 kg of styrene and 4.7 kg of butadiene, and also 318 ml of a 0.0708 mol·l⁻¹ solution of tetrahydrofurfuryl in methylcyclohexane, are injected into a 90 litre reactor, maintained under nitrogen pressure of approximately 2 bar, containing 45.5 kg of methylcyclohexane. After neutralization of the impurities in the solution to be polymerized by addition of n-butyllithium, 644 ml of 0.059 mol·l⁻¹ n-butyllithium in methylcyclohexane are added. The polymerization is carried out at 40° C.

After 70 minutes, the degree of conversion of the monomers reaches 90%. This degree is determined by weighing an extract dried at 140° C. under a reduced pressure of 200 mmHg. 147 ml of a 0.0516 mol·l⁻¹ solution of (3-N,N-dimethylaminopropyl)tri-methoxysilane in methylcyclohexane are added to the living polymer solution. After reacting at 40° C. for 15 minutes, 190 ml of a 0.08 mol·l⁻¹ solution of (3-N,N-dimethylamino-propyl)(methyl)dimethoxysilane in methylcyclohexane are subsequently added to this polymer solution. After reacting at 40° C. for 15 minutes, the solution is antioxidized by addition of 0.8 part per 100 parts of elastomer (phr) of 4,4′-methylenebis(2,6-di(tert-butyl)phenol and of 0.2 part per 100 parts of elastomer (phr) of N-(1,3-dimethylbutyl)-N′-phenyl-p-phenylenediamine. The copolymer thus treated is separated from its solution by devolatilization.

The percentage by weight of chains functionalized at the chain end, determined by the high-resolution SEC technique, is 50%, that of the chains functionalized in the middle of the chain is 20% and that of the 3-branch star-branched chains is 30%. The Mooney viscosity of the polymer A is 70.

The microstructure of this copolymer is determined by the NIR method: the content by weight of trans-1,4-units is 22%, that of cis-1,4-units is 19% and that of 1,2-units is 59%, each of these three contents being with respect to the butadiene units. The content by weight of styrene is 27%.

The glass transition temperature of this copolymer is −23° C.

Preparation of the Polymer B—Polymer not in Accordance with the Invention.

2.0 kg of styrene and 4.7 kg of butadiene, and also 354 ml of a 0.0695 mol·l⁻¹ solution of tetrahydrofurfuryl in methylcyclohexane, are injected into a 90 litre reactor, maintained under nitrogen pressure of approximately 2 bar, containing 45.3 kg of methylcyclohexane. After neutralization of the impurities in the solution to be polymerized by addition of n-butyllithium, 644 ml of 0.059 mol·l⁻¹ n-butyllithium in methylcyclohexane are added. The polymerization is carried out at 40° C.

After 70 minutes, the degree of conversion of the monomers reaches 90%. This degree is determined by weighing an extract dried at 140° C. under a reduced pressure of 200 mmHg. 147 ml of a 0.0516 mol·l⁻¹ solution of (3-N,N-dimethylaminopropyl)tri-methoxysilane in methylcyclohexane are added to the living polymer solution. After reacting at 40° C. for 15 minutes, 294 ml of a 0.0516 mol·l⁻¹ solution of (3-N,N-dimethylamino-propyl)(methyl)dimethoxysilane in methylcyclohexane are subsequently added to this polymer solution. After reacting at 40° C. for 15 minutes, the solution is antioxidized by addition of 0.8 part per 100 parts of elastomer (phr) of 4,4′-methylenebis(2,6-di(tert-butyl)phenol and of 0.2 part per 100 parts of elastomer (phr) of N-(1,3-dimethylbutyl)-N′-phenyl-p-phenylenediamine. The copolymer thus treated is separated from its solution by devolatilization.

The percentage by weight of chains functionalized at the chain end, determined by the high-resolution SEC technique, is 50%, that of the chains functionalized in the middle of the chain is 20% and that of the 3-branch star-branched chains is 30%. The Mooney viscosity of the polymer B is 72.

The microstructure of this copolymer is determined by the NIR method: the content by weight of trans-1,4-units is 21%, that of cis-1,4-units is 19% and that of 1,2-units is 60%, each of these three contents being with respect to the butadiene units. The content by weight of styrene is 28%.

The glass transition temperature of this copolymer is −22° C.

Results

The change in the Mooney viscosity over time of these polymers was evaluated during storage under standard conditions.

Samples of the polymers A and B were wrapped in an air-permeable polyethylene film and stored at a temperature of 25° C., at atmospheric pressure and with the exclusion of light.

Mooney viscosity measurements were carried out at time intervals as they appear in Table 1 below.

TABLE 1

| | |
|---|---|
| Time | Mooney |

| (d) | Polymer A | Polymer B |
|---|---|---|
| 0 | 70 | 72 |
| 4 | 70 | 79 |
| 7 | 70 | 84 |
| 11 | 70 | 89 |
| 15 | 70 | 94 |
| 19 | 70 | 98 |
| 30 | 71 | / |
| 60 | 74 | / |

In Table 1, “/” means that no Mooney measurement was carried out (values measured not very viable above 100).

It is found that the polymer A, a modified diene elastomer according to an embodiment of the invention, does not undergo any change in the Mooney viscosity during the storage period extending over 60 days, in contrast to the control polymer B, which experiences an increase in its Mooney viscosity of 26 Mooney units on conclusion of 19 days of storage.

1. A modified diene elastomer comprising:
(i) from 40 to 80% by weight, with respect to the total weight of the said modified diene elastomer, of the entity functionalized at the chain end by an alkylalkoxysilane group, optionally partially or completely hydrolysed to give silanol, bearing a primary, secondary or tertiary amine function, and bonded to the elastomer via the silicon atom,
(ii) from 5 to 45% by weight, with respect to the total weight of the said modified diene elastomer, of the entity functionalized in the middle of the chain by an alkoxysilane group, optionally partially or completely hydrolysed to give silanol, bearing a primary, secondary or tertiary amine function, and the silicon atom of which bonds the two pieces of the chain,
(iii) from 3 to 30% by weight, with respect to the total weight of the said modified diene elastomer, of the three-branch star-branched entity containing a silane functional group, bearing a primary, secondary or tertiary amine function, and the silicon atom of which bonds the three branches of the chain.

2. A modified diene elastomer according to claim 1, wherein the entity (i) functionalized at the chain end by an alkylalkoxysilane group, optionally partially or completely hydrolysed to give silanol, bearing a primary, secondary or tertiary amine function, and bonded to the elastomer via the silicon atom, corresponds to the following formula (I): 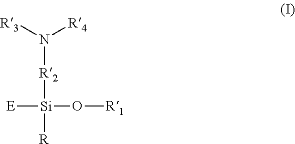
in which:
E denotes the diene elastomer,
R denotes a linear or branched C₁-C₁₀,
R′₁ denotes, as a function of the degree of hydrolysis, a hydrogen atom or a linear or branched C₁-C₁₀,
R′₂ is a saturated or unsaturated, cyclic or non-cyclic, divalent C₁-C₁₈ aliphatic hydrocarbon group or a divalent C₆-C₁₈ aromatic hydrocarbon group,
R′₃ and R′₄, which are identical or different, represent a hydrogen atom or a linear or branched C₁-C₁₈, or else R′₃ and R′₄ form, with N to which they are bonded, a heterocycle containing a nitrogen atom and at least one carbon atom.

3. A modified diene elastomer according to claim 2, wherein R′₁ represents a hydrogen atom or a methyl or ethyl radical.

4. A modified diene elastomer according to claim 2, wherein R′₂ represents the saturated linear divalent C₃ aliphatic hydrocarbon radical.

5. A modified diene elastomer according to claim 2, wherein R′₃ and R′₄, which are identical or different, represent a methyl or ethyl radical.

6. A modified diene elastomer according to claim 1, wherein the entity (ii) functionalized in the middle of the chain by an alkoxysilane group, optionally partially or completely hydrolysed to give silanol, bearing a primary, secondary or tertiary amine function, and the silicon atom of which bonds the two pieces of the chain, corresponds to the following formula (II): 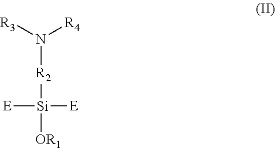
in which:
E denotes the diene elastomer,
R₁ denotes, as a function of the degree of hydrolysis, a hydrogen atom or a linear or branched C₁-C₁₀,
R₂ is a saturated or unsaturated, cyclic or non-cyclic, divalent C₁-C₁₈ aliphatic hydrocarbon group or a divalent C₆-C₁₈ aromatic hydrocarbon group,
R₃ and R₄, which are identical or different, represent a hydrogen atom or a linear or branched C₁-C₁₈, or else R₃ and R₄ form, with N to which they are bonded, a heterocycle containing a nitrogen atom and at least one carbon atom.

7. A modified diene elastomer according to claim 6, wherein R₁ represents a hydrogen atom or a methyl or ethyl radical.

8. A modified diene elastomer according to claim 6, wherein R₂ represents the saturated linear divalent C₃ aliphatic hydrocarbon radical.

9. A modified diene elastomer according to claim 6, wherein R₃ and R₄, which are identical or different represent a methyl or ethyl radical.

10. A modified diene elastomer according to claim 6, wherein the three-branch star-branched entity (iii) containing a silane functional group, bearing a primary, secondary or tertiary amine function, and the silicon atom of which bonds the three branches of the chain, corresponds to the following formula (III):

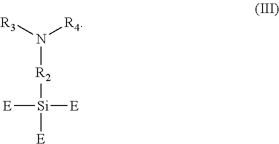

11. A modified diene elastomer according to claim 1, wherein the diene elastomer is a copolymer of butadiene and of a vinylaromatic monomer.

12. A process for the preparation of a modified diene elastomer as defined in claim 1, comprising the following stages:
1) anionic polymerization of at least one conjugated diene in the presence of a polymerization initiator in order to form a living diene elastomer, then
2) addition, to the living diene elastomer obtained in stage 1), of a trialkoxysilane compound bearing a protected primary amine, protected secondary amine or tertiary amine function, the trialkoxysilane bearing a protected primary amine, protected secondary amine or tertiary amine function/polymerization initiator molar ratio varying from 0.05 to 0.35, then
3) addition, to the elastomer solution obtained on conclusion of stage 2), of an alkyldialkoxysilane compound bearing a protected primary amine, protected secondary amine or tertiary amine function, the alkyldialkoxysilane bearing a protected primary amine, protected secondary amine or tertiary amine function/polymerization initiator used in stage 1) molar ratio being greater than or equal to 0.8.

13. A preparation process according to claim 12, wherein the polymerization initiator is chosen from alkyllithium compounds.

14. A preparation process according to claim 12, wherein the trialkoxysilane compound bearing a protected primary amine, protected secondary amine or tertiary amine function corresponds to the formula: 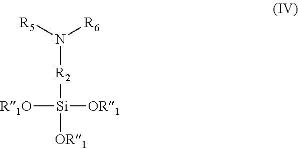
in which:
the linear or branched R″₁ radicals, which are identical to or different from one another, represent a C₁-C₁₀,
R₂ is a saturated or unsaturated, cyclic or non-cyclic, divalent C₁-C₁₈ aliphatic hydrocarbon group or a divalent C₆-C₁₈ aromatic hydrocarbon group,
R₅ and R₆, which are identical or different, represent a trialkylsilyl radical, the alkyl groups, which are identical or different, having from 1 to 4 carbon atoms, or a linear or branched C₁-C₁₈, or else R₅ and R₆ form, with N to which they are bonded, a heterocycle containing a nitrogen atom and at least one carbon atom.

15. A preparation process according to claim 12, wherein the alkyldialkoxysilane compound bearing a protected primary amine, protected secondary amine or tertiary amine function corresponds to the following formula (V): 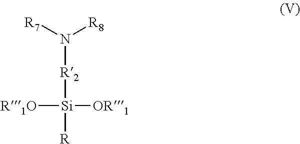
in which:
R denotes a linear or branched C₁-C₁₀,
the R′″₁ radicals, which are identical to or different from one another, represent a linear or branched C₁-C₁₀,
R′₂ is a saturated or unsaturated, cyclic or non-cyclic, divalent C₁-C₁₈ aliphatic hydrocarbon group or a divalent C₆-C₁₈ aromatic hydrocarbon group,
R₇ and R₈, which are identical or different, represent a trialkylsilyl radical, the alkyl groups, which are identical or different, having from 1 to 4 carbon atoms, or a linear or branched C₁-C₁₈, or else R₇ and R₈ form, with N to which they are bonded, a heterocycle containing a nitrogen atom and at least one carbon atom.

16. A reinforced rubber composition based on at least one reinforcing filler and on an elastomer matrix comprising at least one modified diene elastomer as defined in claim 1.

17. A rubber composition according to claim 16, wherein the elastomer matrix predominantly comprises the modified diene elastomer as defined in claim 1.

18. A semi-finished article made of rubber for tires, wherein the article comprises a crosslinkable or crosslinked rubber composition according to claim 16.

19. A tire comprising a semi-finished article as defined in claim 18.
